(19) United States
(12) Patent Application Publication
(10) Pub. No.: US 2017/0076324 A1
(43) Pub. Date: Mar. 16, 2017

(54) Systems and Methods for Directing Advertising Mediums Based on Transaction Data

(71) Applicant: MASTERCARD INTERNATIONAL INCORPORATED, Purchase, NY (US)

(72) Inventor: James J. Waldron, Lake St. Louis, MO (US)

(21) Appl. No.: 14/854,596

(22) Filed: Sep. 15, 2015

(51) Int. Cl. G06Q 30/02

(52) U.S. Cl. CPC G06Q 30/0255; G06Q 30/0275

(57) ABSTRACT

Systems and methods are provided for directing advertising content based on transaction data. An example method includes aggregating transaction data and accessing, by a computing device, bids for advertising content. The bids include a first bid from a first merchant, a first conditional bid based on a first criteria from the first merchant, and a second conditional bid based on a second criteria from a second merchant. The first and second criteria are based on first and second aspects of the aggregated transaction data, respectively. Each bid includes a bid value. The method also includes directing, by the computing device, advertising content to an advertising medium, as indicated by the first merchant, when the aggregated transaction data satisfies the first and second criteria, but the bid value of the first conditional bid is greater than the bid values of the first bid and the second conditional bid.

### FIELD

The present disclosure generally relates to systems and methods for directing advertising mediums based on transaction data and, in particular, to directing advertisement content for a merchant to an advertising medium based on a bid from the merchant and transaction data in a region of the advertising medium.

### BACKGROUND

This section provides background information related to the present disclosure which is not necessarily prior art.

Payment accounts are used by consumers to perform numerous different transactions including, for example, purchasing products (e.g., goods and/or services) from merchants, etc. Transaction data is often generated in connection with the purchase transactions. The transaction data can then be used, for example, to provide insight into purchasing behavior of consumers and/or transaction patterns of and other details related to merchants. Accordingly, a consumer's purchase history can be used to direct advertisements to the consumer, via a variety of mechanisms, including website advertising popups, emails, paper mailings, etc. For example, a loyalty rewards program may offer coupons providing a certain percentage off a next purchase by the consumer at one or more merchants. Further, the purchase history of a consumer may be used to direct advertising to other consumers with a like age, gender, and location.

Separately, dynamic advertising spaces are known. These advertising spaces include display devices, such as LED billboards, which may be changed periodically to thereby multiply a number of products that can be advertised thereon. Not only can different products be advertised, but the particular script, images and/or layout of the particular advertisements, per product, can be changed. Such dynamic advertising spaces are generally positioned to be visible to passengers of vehicles traveling along highways or interstates, etc. Dynamic advertising spaces are also known to be positioned to be visible by pedestrian traffic.

### DRAWINGS

The drawings described herein are for illustrative purposes only of selected embodiments and not all possible implementations, and are not intended to limit the scope of the present disclosure.

FIG. 1 shows an exemplary system for directing advertising content to an advertising medium based on transaction data, and including one or more aspects of the present disclosure;

FIG. 2 is a block diagram of an exemplary computing device, suitable for use in the system of FIG. 1;

FIG. 3 is a flowchart of an exemplary method, which can be implemented via the system of FIG. 1, for directing advertising content to an advertising medium based on one or more bids from merchants, and also based on transaction data in a region of the advertising medium; and

FIGS. 4 and 5 are schematics of exemplary timelines for advertising mediums, that may be generated in connection with the system of FIG. 1 and/or the method of FIG. 3.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Transaction data is often compiled by payment networks, for example, in connection with payment device transactions by consumers at merchants. The transaction data may then be used, by the payment networks, to indicate the potential of the consumers to make certain kinds of purchases and/or be exposed to certain locations. The systems and methods herein employ transaction data to satisfy one or more criteria for directing advertising content to advertising mediums. In particular, bids are solicited and received from merchants for particular advertising mediums (in an auction style). The bids include bid values and, often, at least one criteria of transaction data in one or more regions. For example, a bid may include $5.00 for a 10-minute advertising interval when a 25% increase in total purchases occurs within a last desired number of hours. Transaction data in that time period is aggregated, and if the criteria is satisfied (and the bid is the high bid for all bids having the satisfied criteria), the advertising content, as indicated by that merchant, is directed to the advertising medium. In this manner, the advertising medium is subject to bids, which may be based on transaction data, and therefore purchasing characteristics of the region over the last number of hours. A merchant, or entity associated with the merchant, may thus tailor the bids to capture consumer attention at peak times, or off-peak times, or other relevant times, to improve the visibility of advertising within a budget.

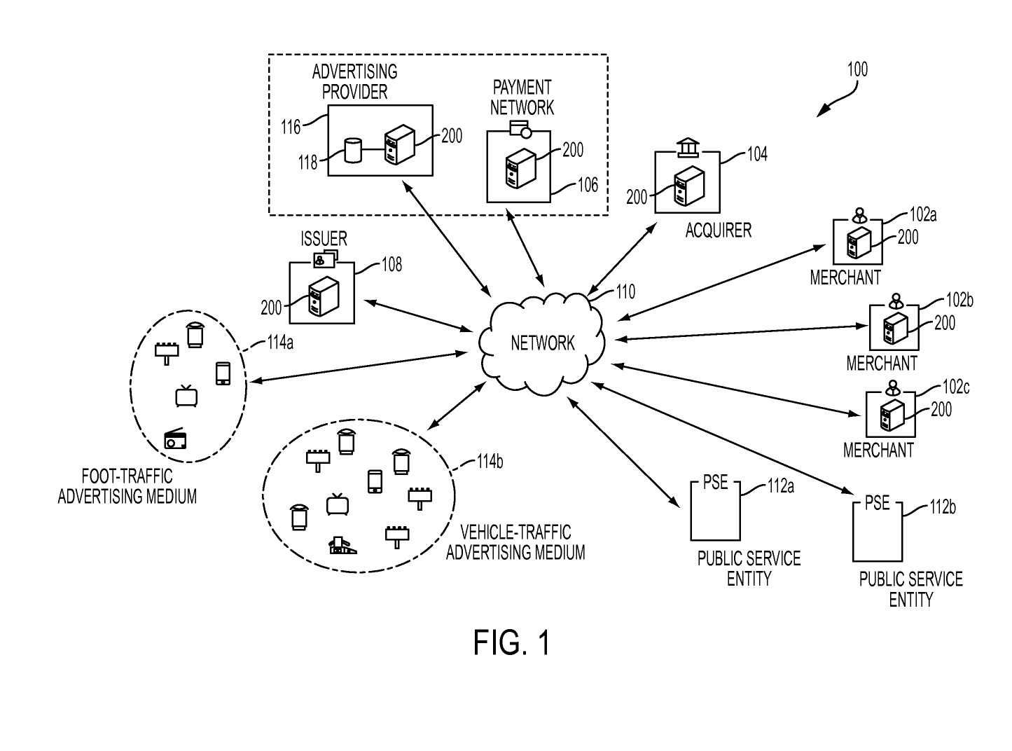

FIG. 1 illustrates an exemplary system 100 in which one or more aspects of the present disclosure may be implemented. Although parts of the system 100 are presented in one arrangement, it should be appreciated that other exemplary embodiments may include the same or different parts arranged otherwise, depending on, for example, processing of payment transactions, access to transaction data, aggregation of transaction data, etc.

As shown in FIG. 1, the illustrated system 100 generally includes merchants 102a-c, an acquirer 104, a payment network 106, and an issuer 108, each coupled to a network 110. The network 110 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof. In one example, the network 110 includes multiple networks, where different ones of the multiple networks are accessible to different ones of the illustrated parts in FIG. 1. In particular in this example, the acquirer 104, the payment network 106, and the issuer 108 may be connected via a private network that is part of network 110 for processing payment transactions, and the merchants 102a-c may be connected with consumers, for example, through a public network, such as the Internet, that is also part of network 110.

In this exemplary embodiment, the merchants 102a-c represent three different merchants, each providing bids for advertising, as described in detail below. In particular in this embodiment, merchants 102a and 102b are coffee shops, at which consumer may purchase coffee, tea, pastries, etc., and merchant 102c is a taxi cab merchant that offers transportation to consumers in exchange for a fare. It should be appreciated that while only three merchants 102a-c offering particular products are provided herein, for purposes of illustration, the system 100 may include any different number and/or type of merchant offering any other products. Furthermore, the system 100 includes two public service entities (PSE) 112a and 112b, each of which is targeted to responsible consumption of alcohol. Again, the subject matter of the PSE is provided for purposes of illustration only, and any PSE with any different mission or directive may be included in other system embodiments. More generally, any different number and/or type of entity may be included in other system embodiments, whereby the entity is interested in advertising any particular content and/or bidding on advertising as described herein. And, while none are illustrated in FIG. 1, it should be appreciated that any number of consumers may be included in, or accommodated by, the system 100.

Generally in the system 100, one of the merchants 102a-c, the acquirer 104, the payment network 106, and the issuer 108 cooperate, in response to a consumer (e.g., a purchase by the consumer), to complete a purchase transaction. In an exemplary transaction, the consumer initiates the transaction by presenting a payment device, such as a card, a payment token, a payment tag, a pass, another device used to provide an account number (e.g., a mobile phone, a tablet, etc.), etc., to merchant 102a (for example). The merchant 102a reads the payment device (associated with a payment account), for example, at a POS terminal, and communicates an account number and an amount of the purchase to the acquirer 104 through the network 110 to determine if the consumer's payment account is in good standing and if there is/are sufficient credit/funds to complete the transaction. The acquirer 104, in turn, communicates with the issuer 108, through the payment network 106, via the network 110, for authorization for the transaction. If the issuer 108 accepts the transaction, an authorization is provided back to the merchant 102a and the merchant 102a completes the transaction. The credit line or funds of the consumer, depending on the type of payment account, is then decreased by the amount of the purchase, and the charge is posted to the account associated with the payment device. The transaction is later cleared and settled by and between the merchant 102a and the acquirer 104 and by and between the acquirer 104 and the issuer 108 (in accordance with settlement arrangements, etc.). Certain accounts, such as debit payment accounts, may further include the use of a personal identification number (PIN) authorization, or other authorization mechanisms, and/or more rapid posting of the charge to the account associated with the card, etc.

Transaction data is generated, collected, and stored as part of the above interactions among the merchant 102a, the acquirer 104, the payment network 106, the issuer 108, and the consumer. The transaction data represents at least a plurality of transactions, e.g., completed transactions, attempted transactions, etc. The transaction data, in this exemplary embodiment, is stored at least by the payment network 106 (e.g., in a data structure associated with the payment network 106, etc.). Additionally, or alternatively, the merchant 102a, the acquirer 104, and/or the issuer 108 may store the transaction data, or part thereof, in a data structure. Or transaction data may be transmitted between the different parts of the system 100, as used or needed. The transaction data may be stored in any desired manner in the system 100. Transaction data may include, for example, payment account numbers, amounts of transactions, merchant IDs, merchant category codes (MCCs), region codes (or other location identifiers) for merchants involved in transactions (or POS terminals associated with the merchants), “Doing Business As” (DBA) names, dates/times of transactions, products purchased and related descriptions or identifiers, etc. It should be appreciated that more or less information related to transactions, as part of either authorization and/or clearing and/or settling, may be included in transaction data and stored within the system 100, at the merchants 102a-c, the acquirer 104, the payment network 106, and/or the issuer 108. Further, transaction data, unrelated to a particular payment account, may be collected by a variety of techniques, and similarly stored within the system 100.

In various exemplary embodiments, consumers and merchants involved in the different transactions herein agree to legal terms associated with their payment accounts, for example, during enrollment in their accounts, etc. In so doing, the consumers and merchants may agree, for example, to allow issuers of the payment accounts, payment networks, etc., to use data collected during enrollment and/or collected in connection with processing the transactions, subsequently for one or more of the different purposes described herein.

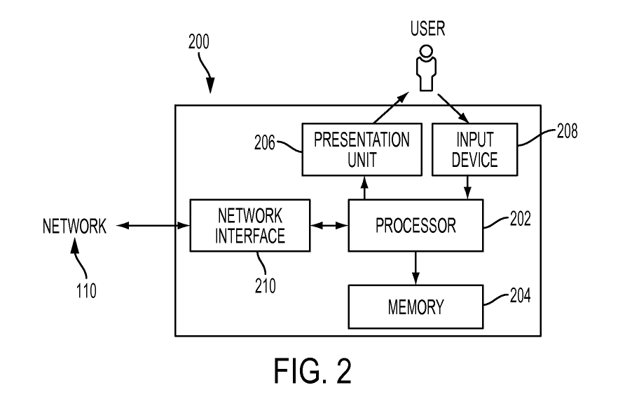

FIG. 2 illustrates an exemplary computing device 200 that can be used in the system 100. The computing device 200 may include, for example, one or more servers, workstations, personal computers, laptops, tablets, smartphones, other suitable computing devices, etc. In addition, the computing device 200 may include a single computing device, or it may include multiple computing devices located in close proximity, or multiple computing devices distributed over a geographic region, so long as the computing devices are specifically configured to function as described herein. In the system 100, each of the merchants 102a-c, the acquirer 104, the payment network 106, and the issuer 108 are illustrated as including, or being implemented in, computing device 200, coupled to the network 110. However, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 generally includes a processor 202 and a memory 204 coupled to the processor 202. The processor 202 may include one or more processing units (e.g., in a multi-core configuration, etc.) including, without limitation, a central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and are not intended to limit in any way the definition and/or meaning of processor.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204, and/or data structures included therein, may be configured to store, without limitation, transaction data, bids, criteria, aspects, MCCs for merchants, region identifiers, and/or other types of data and/or information suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. It should be appreciated that the memory 204 may include a variety of different memories, each implemented in one or more of the functions or processes described herein.

The computing device 200 also includes a presentation unit 206 (or output device or display device) that is coupled to the processor 202 (however, it should be appreciated that the computing device 200 could include output devices other than the presentation unit 206, etc.). The presentation unit 206 outputs information, either visually or audibly to a user of the computing device 200, for example, a consumer, an analyst user associated with the payment network 106 in the system 100, individuals associated with other parts of the system 100, etc. It should be further appreciated that various interfaces (e.g., advertising content, etc.) may be displayed at computing device 200, and in particular at presentation unit 206, to display information, such as, for example, advertising to consumers, etc. The presentation unit 206 may include, without limitation, a liquid crystal display (LCD), a light-emitting diode (LED) display, an organic LED (OLED) display, an “electronic ink” display, etc. In some embodiments, presentation unit 206 includes multiple devices. The computing device 200 further includes an input device 208 that receives inputs from the user of the computing device 200 (i.e., user inputs) such as, for example, bids, criteria, cessation conditions, etc. The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. In various exemplary embodiments, a touch screen, such as that included in a tablet, a smartphone, or similar device, behaves as both a presentation unit 206 and an input device 208.

In addition, the illustrated computing device 200 also includes a network interface 210 coupled to the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 includes the processor 202 and one or more network interfaces incorporated into or with the processor 202.

Referring again to FIG. 1, the system 100 includes multiple advertising mediums 114. As illustrated, the advertising mediums 114 may include a variety of different types of mediums, including, for example, dynamic signage (e.g., billboards, etc.), television, radio, mobile applications, and any other mediums in which advertising content may be displayed and/or changed, etc. Regardless of the particular type of medium, the advertising mediums 114 are configured to display or otherwise present advertising content. The advertising content is often directed by one of the merchants 102, or another entity (e.g., one of the PSEs 112), or other entities on behalf of the merchants 102, for example. As indicated by the dotted lines, the advertising mediums 114 are segregated into two types: a foot-traffic type 114a and a vehicle-traffic type 114b. The former are disposed in positions within a region or region(s) whereby a consumer traveling on foot would be able to view the mediums 114a. The later are disposed at positions, such that a consumer travelling in a vehicle (e.g., a car, train, bus, etc.) would be able to view the mediums 114b. For example, smaller signage may be presented in shopping malls, or urban shopping districts along the side of benches of bus stops, while larger signage (e.g., billboards, etc.) may be presented along roads, highways, interstates, etc. Whatever the locations of the advertising mediums 114, they are dynamic, such that the advertising mediums 114 may present one advertising content at one time, and a different advertising content at another time (i.e., without manual intervention).

It should be appreciated that the advertising mediums 114 may be segregated into more or less or different types and/or regions in other system embodiments, whereby advertising content may be directed more or less precisely to certain consumers. For example, advertising mediums 114 may be segregated by city block, or neighborhood, rather than by postal code. In at least one embodiment, advertising content is directed individually to each of the advertising mediums 114, as described herein.

The system 100 also includes an advertising provider 116, which is illustrated as a standalone part in FIG. 1 that includes, or is implemented in, computing device 200. However, it should be appreciated that, as indicated by the dotted lines in FIG. 1, the advertising provider 116 may be incorporated into the payment network 106. Regardless of its particular location and/or integration, the advertising provider 116, in this embodiment, is coupled to the payment network 106, for example, via network 110, to access transaction data stored therein. In one or more other embodiments, the advertising provider 116 may be integrated with or coupled to one or more other parts of system 100 (e.g., issuer 108, etc.) to thereby access transaction data therefrom.

The advertising provider 116 is also coupled to the advertising mediums 114, via network 110, in order to direct advertising content thereto (i.e., cause advertising content to be displayed thereon, etc.). The advertising provider 116 includes a data structure 118, which is configured to store different advertising content provided by the merchants 102 and the PSEs 112. In addition, the data structure 118 includes bids received from the merchants 102 and PSEs 112, or others (not shown), which includes offers for payment in exchange for the presentation of certain advertising content at the advertising mediums 114. In this exemplary embodiment, the bids are generally conditioned on one or more aspects of transaction data for a particular region (or for particular regions) and a particular category (or for particular categories). However, some default bids provided by the merchants 102 and/or the PSEs 112 may not be so conditioned.

Generally, the advertising provider 116 is configured to access transaction data from the payment network 106 (for example, via a private network that is part of network 110), and aggregate the same, to provide certain aspects of the transaction data (e.g., total amount spend in a region defined by postal code 12345, etc.). The advertising provider 116 is also configured to then accept one or more bids, e.g., the highest bid, for which particular criteria associated with the bid, based on the aggregated transaction data, are satisfied. The advertising provider 116 is further configured to then direct advertising content, as indicated by the merchant 102 or entity who submitted the accepted bid, to the desired advertising mediums 114a and/or advertising mediums 114b (as indicated in the accepted bid). The advertising provider 116 is then configured to generate a transaction to a payment account associated with the merchant 102 or other entity who submitted the accepted bid, from which funds are distributed to an owner, operator, etc. of the particular advertising medium(s) 114 used for the advertisement, etc.

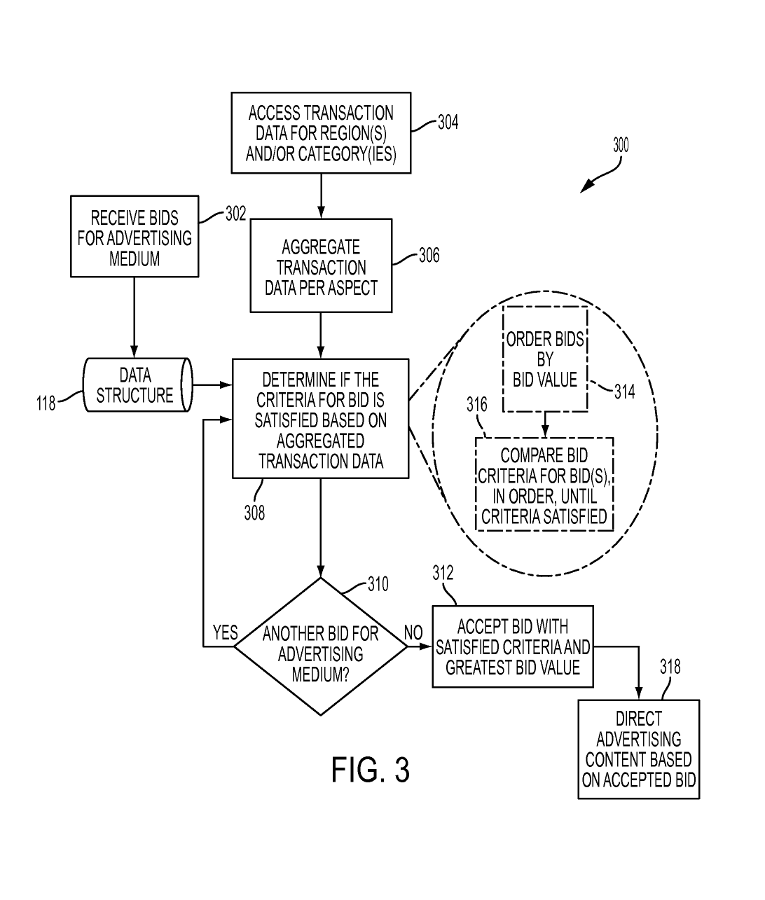

FIG. 3 illustrates an exemplary method 300 for use in directing advertising content to advertising mediums based on transaction data. The exemplary method 300 is described as implemented in the system 100 and, more particularly, in the advertising provider 116 thereof. Further, for purposes of illustration, the exemplary method 300 is described herein with reference to other parts of the system 100 and the computing device 200. As should be understood, however, the methods herein should not be understood to be limited to the exemplary system 100 or the exemplary computing device 200, and the systems and the computing devices herein should not be understood to be limited to the exemplary method 300.

Generally in the method 300, merchants 102 and PSEs 112 provide bids for advertising at one or more of the advertising mediums 114. The bids, in this exemplary embodiment, include one or more bid values for advertising content, at the advertising mediums 114, for one or more intervals of time (e.g., 1 minute, 5 minutes, 10 minutes, 30 minutes, 2 hours, or other suitable interval, etc.) (e.g., $4.00 per 20-minute presentation at one of the advertising mediums 114, etc.). The bid values may be based on one or more criteria related to one or more aspects of transaction data for transactions in at least one particular region and/or involving at least one category. Such aspects may include, without limitation, transaction counts in the region and/or category, total amount spend for transactions in the region and/or category, frequency of transactions, etc., by particular merchant, category of merchants, region of merchants, etc. (e.g., total amount spend at ABC merchant, frequency of transactions at BAR category merchants in a region, etc.). The criteria may then be certain values of the aspects and/or changes in the aspects (e.g., increase in total amount spend by 150% in a 5 hours period, etc.). Further, when a bid includes multiple bid values, one bid value may not be associated with a criteria based on transaction data, i.e., it may be a default bid.

In addition to the above, a bid may include a target date range (e.g., May 1 through June 30, etc.), a target time of day (e.g., morning, AM, midday, afternoon, evening, PM, etc.), another temporal range, one or more target region (e.g., by postal code, etc.), a target traffic type (e.g., vehicle traffic, foot traffic, etc.), etc. Also, the bid may include a cessation condition. For example, a bid may include a daily limit (e.g., $1000, etc.), a daily or consecutive limit on the time interval in which a bid is accepted (e.g., advertising content presented for one consecutive hour, etc.), or other limits at which time the bid should be stopped in order to conform advertising to particular budgets or, for example, to saturating particular regions with advertising in limited intervals, etc. It should be appreciated that still other conditions may be included in the bids, which may cause the bids to be limited, other than by transaction data, etc.

Table 1 illustrates multiple example bids from merchants 102a-b, in connection with advertising at one of the advertising mediums 114, in which the merchants 102a-b are both coffee shops in the vicinity of multiple book stores. In addition to the specific criteria (per aspect) identified in Table 1, merchant 102a further limits its bids generally to a date range of May 1 to May 31, a region defined by postal code 12345, AM times, and foot traffic advertising mediums 114a, with a cessation condition of when the sales of merchant 102a increase 150% over a 2 hours interval. Similarly, merchant 102b further limits its bids generally to a region defined by postal code 12345, but does not limit by time of day or traffic type (i.e. a bid is all day and for all traffic type advertising mediums 114), with a cessation condition of when a daily budget of $1000 is reached and/or when advertising is displayed for more than 5 consecutive hours.

TABLE 1

| | | | Bid |
|---|---|---|---|
| Merchant | Aspect | Criteria | Value |
| Merchant | Total Amount Spend at Merchant | Increase 110% | $10.00 |
| 102a | Location, Book Store, | | |
| | 123 Main St. | | |
| | Total Amount Spend by BOOK | Increase 110% | $6.00 |
| | Category | | |
| | Total Amount Spend by BOOK | Increase 50% | $4.00 |
| | Category | | |
| | Default | | $1.00 |
| Merchant | Total Amount Spend by BOOK | Increase 150% | $9.00 |
| 102b | Category during 5 hrs. | | |
| | Total Amount Spend by BOOK | Increase 50% | $3.00 |
| | Category during 5 hrs. | | |
| | Default | | $2.00 |

Similarly, Table 2 illustrates example bids from PSEs 112a-b and from merchant 102c, which generally relate to responsible consumption of alcohol. In this exemplary embodiment, the PSEs 112a-b are seeking to disseminate messages related to avoiding drinking and driving, and the merchant 102c is a taxi cab merchant. Similar to merchants 102a-b, in addition to the specific criteria identified in Table 2, PSE 112a further limits its bids generally to a target region defined by postal codes 12345 and 54321, between 7:00 PM and 3:00 AM, and all traffic type advertising mediums 114, with a cessation condition of when a daily budget of $6000 is reached. The PSE 112b further limits its bids generally to a target region defined by postal codes 12345 and 54321, only PM times, and all traffic type advertising mediums 114, with a cessation condition of when a daily budget of $4000 is reached. And, merchant 102c limits its bids generally to a target region defined by postal codes 12345 and 54321, all day, and foot-traffic only advertising mediums 114a, with a cessation condition of when a daily budget of $1000 is reached.

TABLE 2

| Merchant | Aspect | Criteria | Bid Value |
|---|---|---|---|
| PSE 112a | Total Amount Spend by BAR | Increase 110% | $10.00 |
| | Category during 5 hrs. | | |
| | Total Amount Spend by BAR | Increase 50% | $6.00 |
| | Category during 5 hrs. | | |
| | Default | | $4.00 |
| PSE 112b | Default | | $3.00 |
| Merchant | Total Amount Spend by BAR | Increase 75% | $15.00 |
| 102c | Category during 3 hrs. | | |
| | Total Amount Spend by BAR | Increase 50% | $10.00 |
| | Category during 3 hrs. | | |
| | Default | | $1.00 |

As shown in FIG. 3, when the bids are submitted by the merchants 102 and the PSEs 112, the bids are received by the advertising provider 116, at 302, and stored in the data structure 118. It should be appreciated that multiple bids may be received at regular or irregular intervals from a variety of merchants (including the merchants 102), PSEs (including the PSEs 112) and/or other entities, and that the bids may include a variety of different criteria, in general and/or based on different aspects of transaction data. Further, as indicated above, the bids may be received from a variety of merchants, PSEs and/or other entities in a variety of categories and/or regions. More generally, the merchants, PSEs and/or other entities need not be related to the same types of products, in order to compete (or bid) for the same advertising mediums 114.

Separately in the method 300, the advertising provider 116 accesses transaction data for transactions in one or more regions and in one or more categories, at 304. In general, the transaction data is accessed based on the bids included for a particular one of the advertising mediums 114, or group of the advertising mediums 114. For example, the bids of Table 1 are limited to a region defined by postal code 12345, and the bids of Table 2 are directed to a region defined by postal codes 12345 and 54321. As such, the advertising provider 116 accesses transaction data for transactions within the regions defined by those postal codes. And, the advertising provider 116 further limits the access to transactions in the BOOK and BAR categories (e.g., based on MCC, etc.), because the transaction data is limited to the BOOK category by merchant aspect in Table 1 and the BAR category by PSE/merchant aspect in Table 2. With that said, even though one bid from merchant 102a is specific to the “Book Store,” transactions to that merchant are not separately accessed because they are captured in the BOOK category. It should be appreciated that an unlimited number of regions and/or categories or other limits may be used by the advertising provider 116 to access only the transaction data to be used in determining whether transaction data does or does not satisfy bid criteria. In at least one embodiment, however, the advertising provider 116 may access additional data in order to provide ease of access and/or based on other conditions related to transaction data access, or for one or more other reasons.

Once the transaction data is accessed, the advertising provider 116 aggregates, at 306, the transaction data by one or more aspects indicated in one or more of the bids in data structure 118 for the advertising mediums 114. For example, based on the bids in Table 1, the advertising provider 116 aggregates all transactions in the BOOK category to determine a total amount spend for the category, and further aggregates all transaction to the Book Store located at 123 Main St. to determine a total amount spend for that particular merchant. Finally, based on the bids in Table 2, the advertising provider 116 aggregates total amount spend for the BAR category in the region defined by the two postal codes 12345 and 54321. Again, it should be appreciated that the manner in which transactions are aggregated is often based on the aspects indicated in bids submitted by merchants, PSEs and other entities, but that other techniques for aggregating transaction data may be employed.

It should be further appreciated that the aspects are often time indicative, to improve the responsiveness of the advertising content directed based on the bids. Generally, in order for the merchants 102 and/or PSEs 112 to reap the benefit of increased foot traffic in a region or in a vicinity of a merchant (e.g., merchant 102a, etc.), etc., the advertising content would need to be displayed within the duration of the increased traffic. As such, the transaction data is accessed and/or aggregated at regular or irregular intervals. For example, the advertising provider 116 may access transaction data, at 304, and aggregate the data, at 306, every 20 minutes, 30 minutes, hour, etc. Often the interval, at which the advertising provider accesses and aggregates data, will be based on the interval at which advertising content may be altered at the advertising mediums 114. For example, if advertising medium 114a is subject to a 15 minute advertising interval (i.e., a bid is accepted every 15 minutes), the advertising provider 116 will access and aggregate transaction data at least once within the interval (if bids for the advertising medium 114a are based on transaction data aspects) to ensure the advertising provider 116 accepts the proper bid, as described below. Likewise, if advertising medium 114b is subject to a 60 minute advertising interval, the advertising provider 116 will access and aggregate transaction data at least once per hour (if bids for the advertising medium 114b are based on transaction data aspects) to ensure the advertising provider 116 accepts the proper bid.

After, the advertising provider 116 determines, at 308, if the aggregated transaction data satisfies the criteria for the one or more bids for the advertising mediums 114 in the data structure 118. In particular, the advertising provider 116 compares the criteria for a first bid to the aggregated data, whereby the aggregated data either satisfies the criteria or not. Then, the advertising provider 116 determines, at 310, if another bid for the advertising mediums 114 is included in the data structure 118. If it is, the advertising provider 116 again determines if the criteria for the next bid is satisfied, at 308, and then determines if another bid for the advertising mediums 114 exists, at 310. If no further bids exist for the advertising mediums 114, the advertising provider 116 accepts the bid, for which the criteria is satisfied, having the highest bid value, at 312. In cases where multiple bids, for which the criteria is satisfied, have the same bid values, i.e., they tie, the ties may be resolved by the advertising provider 116 in various manners. Without limitation, the ties may be resolved by random selection of one of the bids, by selecting the bid received first in time, by selecting the bid that is associated with the longest active advertising campaign based on timestamp (giving the effect of the first bidder winning even though the bids may be viewed as simultaneous), by selecting the bid that has the most money left to spend on advertising, by selecting the bid that is most likely to reach its spend limit for advertising so as to maximize profit for the advertising provider 116, or by other processes, etc.

It should be appreciated that the advertising provider 116 need not determine if the criteria for all bids is satisfied before accepting a bid. For example, in FIG. 3, the advertising provider 116 may optionally, as indicated by the dotted lines, order the bids for the advertising mediums 114 based on bid value, at 314, and then compare the bid criteria for the bids, at 316, in order, from the highest bid to the lowest bid, to determine if the criteria is satisfied. Then, when the advertising provider 116 determines the criteria is satisfied for a first one of the bids, the advertising provider can stop and accept the bid, at 312, because, based on the ordering of the bids, it has the highest bid.

It should also be appreciated that multiple bids may be accepted, at 312, depending on the manner in which the advertising mediums 114 are segregated, for example. Specifically, as described below, the advertising provider 116 may accept one bid for foot-traffic advertising medium 114a and a separate bid for vehicle-traffic advertising medium 114b. As such, certain of the operations in method 300 may be repeated, as necessary, to accept a bid for each or multiple available advertising mediums 114 for multiple time intervals, etc.

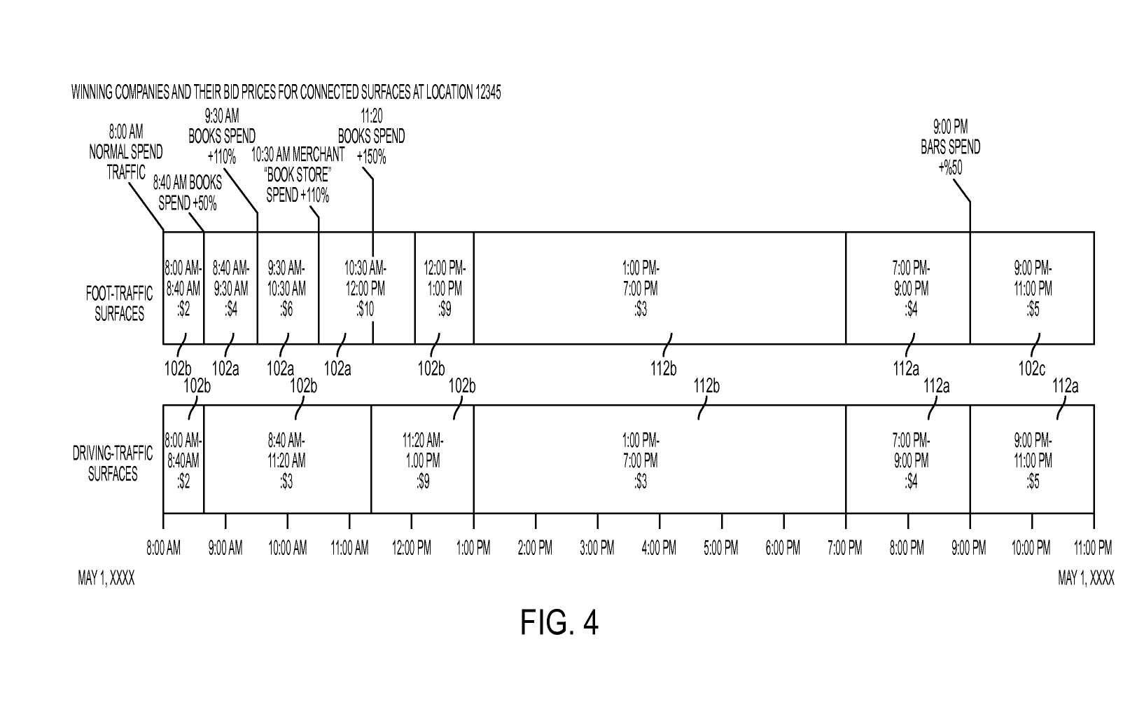

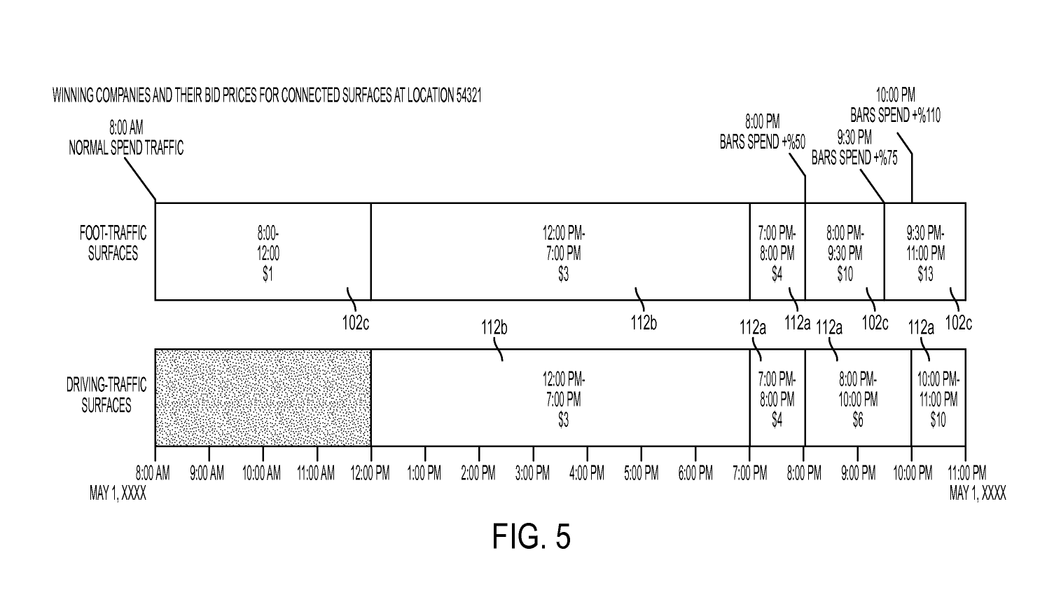

FIGS. 4-5 illustrate time lines for foot-traffic advertising medium 114a and vehicle-traffic advertising medium 114b, in the regions defined by postal codes 12345 (FIG. 4) and 54321 (FIG. 5), in connection with the example bids in Tables 1 and 2 and the progression of transactions in the defined regions.

As shown in FIG. 4, as related to the region defined by postal code 12345, at 8:00 AM on May 1, normal spending is initially determined based on the aggregated transaction data for the BOOK category, the BAR category, and the Book Store aspects. As such, none of the transaction data criteria for the bids in Tables 1 and 2 are satisfied, leaving the default bids from the merchants 102a-c and the PSEs 112a-b. However, 8:00 AM falls outside of the time-of-day limit for the PSEs 112a-b. Thus, between the default bids of the merchants 102a-c, the default bid from merchant 102b is the greatest, and as shown, the advertising provider 116 therefore accepts the $2.00 bid from the merchant 102b for all advertising mediums 114.

As transaction data is accessed and aggregated, the advertising provider 116 continues to compare bid criteria for aspects of the aggregated transaction data as time progresses on May 1.

At 8:40 AM, the advertising provider 116 identifies that the total amount spend in the BOOK category is up 50%. As a result, the advertising provider 116 compares the bids to the aggregated transaction data. In doing so, the advertising provider 116 determines that the criteria for the increased bid of $4.00 from merchant 102a is now satisfied, and also determines the criteria for the increased bid of $3.00 from the merchant 102b is also satisfied (at 308 in method 300). The bids from the PSEs 112a-b and merchant 102c are unchanged. Thus, because the bid from merchant 102a is higher, the advertising provider 116 accepts (at 312 in method 300) the bid for foot-traffic advertising mediums 114a, and further accepts (at 312 in method 300) the bid from merchant 102b for the vehicle-traffic advertising mediums 114b.

At 9:30 AM, the advertising provider 116 determines that the total amount spend in the BOOK category has gone up 110%. As a result, the criteria for an increased bid of $6.00 for the merchant 102a is now satisfied (at 308 in method 300). The $6.00 bid is the highest bid for the foot-traffic advertising medium 114a, and is thus accepted by the advertising provider 116 (at 312 in method 300). The $3.00 bid from the merchant 102b continues to be accepted by the advertising provider 116 as the highest bid for the vehicle-traffic advertising medium 114b. At 10:30 AM, the Book Store's total amount spend increases by 110%, thereby satisfying the bid criteria (at 308 in method 300) to raise the bid from merchant 102a to $10.00. This bid is now the highest and is thus accepted by the advertising provider 116 (at 312 in method 300) for foot-traffic surfaces. At 11:20 AM, the total amount spend for the BOOK category increases to 150%, which causes the bid from the merchant 102b to be increased to $9.00 (for the driving traffic surfaces). And, at 12:00 PM, the bid from merchant 102a is stopped (i.e., the cessation condition for merchant 102a, of advertising during AM times only as described above, is now satisfied). The $9.00 bid from the merchant 102b is thus now the highest bid for the foot-traffic advertising medium 114a and the vehicle-traffic advertising medium 114b. The $9.00 bid from merchant 102b is thus accepted (at 312 in method 300).

With continued reference to FIG. 4, at 1:00 PM, the bids from merchant 102b are stopped, due to cessation conditions (i.e., it has reached 5 consecutive hours of advertising, etc.). And, the default $3:00 bid from the PSE 112b is now the high bid, and is thus accepted (at 312 in method 300), for the foot-traffic advertising medium 114a and the vehicle-traffic advertising medium 114b. At 7:00 PM, the default $4:00 bid from the PSE 112a is the high bid, and is thus accepted (at 312 in method 300), for the foot-traffic advertising medium 114a and the vehicle-traffic advertising medium 114b. At 9:00 PM, the total amount spend in the BAR category increases by 50%, thereby satisfying (at 308 in method 300) the criteria for a $10.00 bid from the merchant 102c for the foot-traffic advertising medium 114a and a $6.00 bid from PSE 112a for all advertising mediums 114 (for all traffic types). In turn, the advertising provider 116 accepts the $10.00 bid from the merchant 102c for the foot-traffic advertising medium 114a (at 312 in method 300) and accepts the $6.00 bid from the PSE 112a for the vehicle-traffic advertising medium 114b.

Turning to FIG. 5, as related to the region defined by postal code 54321, at 8:00 AM on May 1, normal spending is initially determined based on the aggregated transaction data for the BAR category aspects. As such, none of the transaction data criteria for the bids in Table 2 are satisfied, leaving the default bids from the merchant 102c and the PSEs 112a-b. However, 8:00 AM falls outside of the time of day limit for the PSEs 112a-b, and merchant 102c limits bids to only the foot-traffic advertising medium 114a. Thus, the advertising provider 116 accepts the $1.00 bid from the merchant 102c for the foot-traffic advertising medium 114a. The lack of satisfying bids for the vehicle-traffic advertising medium 114a leaves it unclaimed at this time, and allows the owner(s) to leave it empty or display their own advertising message(s), etc. At 12:00 PM, the default bid for the PSE 112b becomes the highest bid for all advertising mediums 114, and is accepted by the advertising provider 116. And, at 7:00 PM, the default bid for the PSE 112a becomes the highest bid for all advertising mediums 114, and is accepted by the advertising provider 116.

At 8:00 PM, the advertising provider 116 determines that the total amount spend in the BAR category has gone up 50%. As a result, the criteria for an increased bid of $6.00 for the PSE 112a is now satisfied as is the criteria for an increased bid of $10.00 for merchant 102c (at 308 in method 300). The $10.00 bid from merchant 102c is the highest bid for the foot-traffic advertising medium 114a, and is thus accepted by the advertising provider 116 (at 312 in method 300). The $6.00 bid from the PSE 112a is the highest bid for the vehicle-traffic advertising medium 114b, and is thus accepted by the advertising provider 116 (at 312 in method 300). At 9:30 PM, the BAR category increases by 75%, thereby satisfying the bid criteria (at 308 in method 300) to raise the bid from merchant 102c to $15.00. This bid is now the highest for the foot-traffic advertising medium 114a and is thus accepted by the advertising provider 116 (at 312 in method 300). No change in the accepted bid occurs for the vehicle-traffic advertising medium 114a.

With continued reference to FIG. 5, at 10:00 PM, the total amount spend for the BAR category increases to 110%, which causes the bid from the PSE 112a to be increased to $10.00. The $10.00 bid is now the highest bid for the vehicle-traffic advertising medium 114b, and the $10.00 bid from the PSE 112a is accepted (at 312 in method 300). The $15.00 bid from merchant 102c continues to be the highest for the foot-traffic advertising medium 114a.

With reference again to FIG. 3, after a bid is accepted, the advertising provider 116 then directs advertising content, as indicated by the merchant, PSE and/or other entity with the accepted bid, to be displayed at the appropriate advertising mediums 114a and 114b, at 318.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of: (a) aggregating transaction data for transactions occurring in at least one region and involving at least one category; (b) accessing multiple bids for advertising content at the advertising medium, wherein the multiple bids include at least a first bid from a first merchant, a first conditional bid based on a first criteria from the first merchant, and a second conditional bid based on a second criteria from a second merchant, the first criteria based on a first aspect of the aggregated transaction data, the second criteria based on a second aspect of the aggregated transaction data, each bid including a bid value; (c) directing advertising content to the advertising medium, as indicated by the first merchant, when the aggregated transaction data satisfies both the first criteria and the second criteria, but the bid value of the first conditional bid is greater than the bid values of the first bid and the second conditional bid; (d) directing advertising content to the advertising medium, as indicated by the first merchant, when the aggregated transaction data satisfies neither the first criteria nor the second criteria; (e) generating a transaction to a payment account associated with the first merchant for the advertising content, after directing the advertising content to the advertising medium.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “connected to,” or “coupled to” another element, it may be directly on, connected or coupled to the other element, or intervening elements may be present. In contrast, when an element is referred to as being “directly on,” “directly connected to,” or “directly coupled to” another element, there may be no intervening elements present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature could be termed a second feature without departing from the teachings of the example embodiments.

What is claimed is:

1. A computer-implemented method for use in providing advertising content at an advertising medium based on transaction data, the method comprising:
aggregating transaction data for transactions occurring in at least one region and involving at least one category;
accessing, by a computing device, multiple bids for advertising content at the advertising medium;
wherein the multiple bids include at least a first bid from a first merchant, a first conditional bid based on a first criteria from the first merchant, and a second conditional bid based on a second criteria from a second merchant, the first criteria based on a first aspect of the aggregated transaction data, the second criteria based on a second aspect of the aggregated transaction data, each bid including a bid value; and
directing, by the computing device, advertising content to the advertising medium, as indicated by the first conditional bid, when the aggregated transaction data satisfies both the first criteria and the second criteria, but the bid value of the first conditional bid is greater than the bid value of the first bid and the bid value of the second conditional bid.

2. The method of claim 1, wherein the first aspect of the aggregated transaction data includes an amount transacted in the at least one category within the at least one region; and
wherein the first criteria includes a percentage change in said amount transacted.

3. The method of claim 2, further comprising directing, by the computing device, advertising content to the advertising medium, as indicated by the second merchant, when the aggregated transaction data satisfies both the first criteria and the second criteria, but the bid value of the second conditional bid is greater than the bid values of both the first bid and the first conditional bid.

4. The method of claim 1, further comprising directing, by the computing device, advertising content to the advertising medium, as indicated by the first bid, when the aggregated transaction data satisfies neither the first criteria nor the second criteria.

5. The method of claim 1, wherein the first merchant is included in a category different than the at least one category.

6. The method of claim 5, wherein the second merchant is included in a category different than the first merchant.

7. The method of claim 1, wherein aggregating the transaction data includes aggregating the transaction data for an interval within a last day.

8. The method of claim 1, further comprising generating, by the computing device, a transaction to a payment account associated with the first merchant for the advertising content, after directing the advertising content to the advertising medium.

9. The method of claim 1, wherein directing the advertising content includes directing the advertising content to the advertising medium, as indicated by the first conditional bid, for a first increment; and
further comprising directing a different advertising content to the advertising medium, as indicated by the second conditional bid, when the aggregated transaction data satisfies the second criteria and the second conditional bid is higher than the first bid and the first conditional bid, and after the first increment.

10. A non-transitory computer-readable storage media including executable instructions, which when executed by at least one processor, cause the at least one processor to:
aggregate transaction data for transactions occurring in at least one region and involving at least one category;
receive multiple bids for advertising content at an advertising medium, each of the multiple bids including at least one criteria based on the aggregated transaction data and a bid value associated with the at least one criteria, at least some of the multiple bids associated with different merchants;
for each of the multiple bids, compare the at least one criteria and the aggregated transaction data; and
direct advertising content to the advertising medium associated with one of the multiple bids, when the aggregated transaction data satisfies the at least one criteria associated with said one of the multiple bids and when the bid value associated with said one of the multiple bids is greater than bid values for all other ones of the multiple bids for which the aggregated transaction data also satisfies the at least one criteria.

11. The non-transitory media of claim 10, wherein the multiple bids include at least a first bid and a second bid; and
wherein the first bid includes at least a first bid value based on a first criteria associated with the aggregated transaction data and a second bid value based on a second criteria associated with the aggregated transaction data; and
wherein the second bid includes at least a first bid value based on a first criteria associated with the aggregated transaction data.

12. The non-transitory media of claim 11, wherein the first criteria and the second criteria of the first bid relate to a first aspect and a second aspect, respectively, of the aggregated transaction data.

13. The non-transitory media of claim 12, wherein the first and second aspects include a total amount for transactions involving the at least one category and occurring in the at least one region; and/or
wherein the first and second aspects include a percentage change in said total amount for transactions involving the at least one category and occurring in the at least one region.

14. The non-transitory media of claim 11, wherein the merchant associated with the first bid is included in a category different than the at least one category of the transactions for which transaction data is aggregated.

15. The non-transitory media of claim 11, wherein the first criteria of the first bid and second bid are the same; and
wherein the executable instructions, when executed by the at least one processor, cause the at least one processor, in order to direct the advertising content, to direct the advertising content to the advertising medium as indicated by the merchant associated with the first bid, when the aggregated transaction data satisfies the first criteria and when the first bid value of the first bid is greater than the first bid value of the second bid.

16. The non-transitory media of claim 11, wherein the first and second bids each include a default bid value; and
wherein the executable instructions, when executed by the at least one processor, cause the at least one processor, in order to direct the advertising content, to direct the advertising content to the advertising medium as indicted by the merchant associated with the first bid, when the aggregated transaction data satisfies none of the conditions of the first and second bids and when the default bid value of the first bid is greater than the default bid value of the second bid.

17. The non-transitory media of claim 11, wherein the executable instructions, when executed by the at least one processor, cause the at least one processor, in order to direct the advertising content, to direct the advertising content to the advertising medium as indicated by the merchant associated with the first bid for a first interval; and
wherein the executable instructions, when executed by the at least one processor, further cause the at least one processor to direct advertising content to the advertising medium as indicated by the merchant associated with the second bid, after the first interval.

18. The non-transitory media of claim 10, wherein the executable instructions, when executed by the at least one processor, cause the at least one processor, in order to aggregate transaction data, to aggregate the transaction data for at least some transactions occurring within a last three hours, but not for transactions occurring more than 10 hours prior.

19. A system for use in providing advertising content at an advertising medium based on transaction data, the system comprising:
a data structure comprising advertising content for multiple entities and bids received from the multiple entities for providing the advertising content at the advertising medium, each of the bids including at least one transaction-based criteria and a bid value associated with the at least one transaction-based criteria; and
at least one processor coupled to the data structure and configured, by executable instructions, to:
aggregate transaction data for transactions occurring in at least one region and involving at least one category;
for each of the multiple bids, compare the at least one transaction-based criteria and the aggregated transaction data;
direct advertising content associated with one of the bids to the advertising medium when the aggregated transaction data satisfies the at least one transaction-based criteria associated with said one of the bids, and when the bid value associated with said one of the bids is greater than bid values for all other ones of the bids for which the aggregated transaction data also satisfies the corresponding at least one transaction-based criteria; and
generate a transaction to a payment account of the entity associated with said one of the bids for the advertising content.

20. The system of claim 19, wherein the at least one processor is further configured to:
aggregate the transaction data for an interval within a last day;
direct the advertising content associated with said one of the bids to the advertising medium for a first increment; and
direct a different advertising content associated with another one of the bids to the advertising medium when the aggregated transaction data satisfies another at least one transaction-based criteria associated with said another one of the bids, and when the bid value associated with said another one of the bids is greater than bid values for all other ones of the bids for which the aggregated transaction data also satisfies the corresponding another at least one transaction-based criteria.
